(19) United States
(12) Patent Application Publication
(10) Pub. No.: US 2004/0050706 A1
(43) Pub. Date: Mar. 18, 2004

(54) Copper electroplating method using insoluble anode

(76) Inventors: Masaru Seita, Saitama (JP); Hideki Tsuchida, Saitama (JP); Masaru Kusaka, Saitama (JP)

Correspondence Address: EDWARDS & ANGELL, LLP, P.O. BOX 9169, BOSTON, MA, 02209, US

(21) Appl. No.: 10/398,829

(22) PCT Filed: Oct. 9, 2001
(86) PCT No.: PCT/JP01/08853

(30) Foreign Application Priority Data
Oct. 10, 2000 (JP) 2000-309456

(51) Int. Cl. H01M 4/02; B41M 5/20; C25D 7/00; C25D 3/38

(52) U.S. Cl. 205/50; 205/296; 428/543; 428/935

(57) ABSTRACT

The present invention provides a copper electroplating method using an insoluble anode, including: using an insoluble anode and a copper electroplating solution which contains a compound having a —X—S—Y— structure (where X and Y are each independently selected from the group consisting of a hydrogen atom, a carbon atom, a sulfur atom, a nitrogen atom, and an oxygen atom, and X and Y can be the same only where they are carbon atoms); and using direct current to plate a substrate. By this method, even a certain time period after the initial make-up of the electrolytic bath, stable deposition of the plated metal and formation of a filled via can be achieved, and an MVH can be filled up with the metal with no void left.

### TECHNICAL FIELD

The present invention relates to a copper electroplating method in which an insoluble anode and a copper electroplating solution that contains a specific compound having a sulfur atom are used, and a substrate is plated by using direct current. The present invention also relates to a composite material manufactured by the copper electroplating method.

### BACKGROUND ART

In recent years, with the advent of high performance and compact electronics such as personal computers, there has been a strong demand for printed wiring boards with higher density and reduced thickness. One of the methods to meet such a requirement uses a multilayered printed wiring board (build-up printed wiring board), which is manufactured through a build-up process including the steps of sequentially stacking layers and patterning the layers.

Generally, such a build-up printed wiring board has a hole called a microvia hole (MVH) for electrical connection between adjacent layers, and the MVH is about 100 μm in diameter and about 100 μm in depth and plated with copper on its inner wall surface.

In such a conventional process, however, only the inner wall surface of the MVH is plated with copper, and the inner space of the MVH is filled with an insulating resin. When the resin used in such a process is viscous, it is difficult to fill up a hole that has a small diameter and is not a through hole. If the MVH space is left partially unfilled after the filling step with the resin, the air remaining in the MVH may be quickly expanded by heat in soldering the printed wiring board, leading to deformation or destruction of the printed wiring board. In the conventional process, therefore, the diameter of the MVH has to be large enough to facilitate the resin filling, which causes a drawback to the miniaturization of the build-up printed wiring board.

Into the conventional process, the Via on Via process, in which MVHs are stacked for the connection to the upper layer, can not be adopted, because the insulating resin is placed over the top of the MVH. This may reduce the area efficiency and design flexibility of the build-up printed wiring board. (See FIG. 1.)

A method to solve to the problem, called a Via-filling, is provided in which the MVH is entirely filled with a conductor to form an electrical connection between the adjacent layers in the build-up printed wiring board. (See FIG. 1.)

The Via-filling helps the miniaturization and increase of density of the printed wiring board, because it can increase the effective area of the printed wiring board and give a sufficient electrical connection even through a smaller diameter of the MVH in contrast to the conventional process in which only the inner wall surface is plated.

The Via-filling processes developed and disclosed at present include:

(1) a method in which the MVH is filled with a conductive paste by printing; and

(2) a method in which the conductor layer only at the bottom surface of the MVH is activated, and copper layers are selectively stacked by electroless plating.

However, since the conductive paste, which is a mixture of copper and an organic material, has a lower conductivity than that of copper metal, the small diameter MVH cannot provide sufficient electrical connection, and therefore the method with the conductive paste can hardly be useful in miniaturizing and increasing the density in the printed wiring board. The via hole with a small diameter cannot be completely filled up with a viscous paste with no void left by printing, because of the viscosity of the paste.

The method using electroless copper plating is superior to the conductive paste method in that the material charged into the MVH is a highly conductive deposition of copper metal. However, the method suffers from a low deposition rate and low productivity of the plated coating film. When a general high-speed type of electroless copper plating bath is used, the deposition rate of the plated coating film is about 3 μm/hr. According to this process, it will take 30 hours or more to fill up a typical MVH of 100 μm in diameter and 100 μm in depth with the plated copper, and the productivity is very low.

In contrast, the copper electroplating has a relatively high deposition rate of 10 to 50 μm/hr and can significantly reduce the time required for the electroless copper plating, and therefore the application of the electroless copper plating to the MVH is expected. In the copper electroplating, copper cannot be deposited only on the bottom surface of the MVH, because such a place is electrically isolated. Therefore, the entire inner surface of the MVH is provided with conductivity either by coating with a thin electroless-plated copper or direct plating, and then the copper is deposited on the entire inner surface of the MVH. Inside the MVH, however, the deposition rate of the conventional copper electroplating is very low, and therefore it has been considered impractical to fill up the MVH by copper electroplating.

If the copper plating is deposited on the entire inner surface of the MVH, in order to fill the inside of the MVH with the plated copper with no void remaining, the deposition rate near the bottom surface of the MVH should be higher than that at the opening of the MVH. If the deposition rate at the opening is higher than that near the bottom surface, the opening would be closed with void left inside the MVH before the MVH is completely filled with the plated copper. The void formed in the copper deposition may cause deformation or destruction of the printed wiring board, because the substances captured in the void (the plating solution or hydrogen gas) may be quickly expanded in soldering on-board parts to the printed wiring board at high temperature.

In manufacturing the printed wiring board, a copper electroplating bath containing a specific brightener is generally used, and the direct current electrolysis using a soluble anode such as a phosphorus-containing copper anode is general as the condition for electrolysis. In the plating process using the soluble anode, however, the copper electroplating bath may become unstable when the electrolysis is interrupted. If the copper electroplating solution is used after the interruption, bulky grains can be formed in the electroplated copper layer, and formation of the filled via can become unstable. There has been an urgent demand for a solution to the problems.

The present invention has been made in light of the situation described above, and an object of the present invention is to provide a copper electroplating method characterized by using direct current and an insoluble anode and particularly a copper electroplating method suitable for the filled via formation.

### DISCLOSURE OF INVENTION

The present invention is directed to a copper electroplating method characterized by including: using an insoluble anode and a plating solution that contains a compound having a —X—S—Y— structure (where X and Y are each independently selected from the group consisting of a hydrogen atom, a carbon atom, a sulfur atom, a nitrogen atom, and an oxygen atom, and X and Y can be the same only where they are carbon atoms); and using direct current to plate a substrate.

### BRIEF DESCRIPTION OF DRAWINGS

FIG. 1 is a schematic view showing build-up wiring boards;

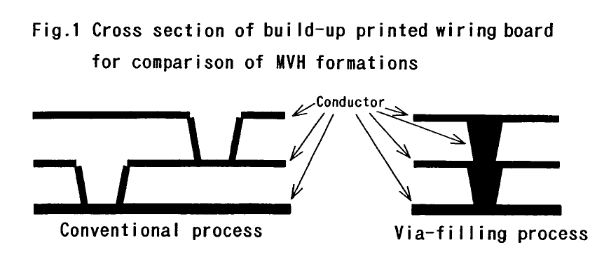

FIG. 2 is a schematic view showing vias each of which is filled by using an insoluble electrode and by using either the bath immediately after the initial make-up or the bath three days after an interruption of the electrolysis, in copper electroplating; and

FIG. 3 is a schematic view showing vias each of which is filled by using a insoluble electrode and by using either the bath immediately after the initial make-up or the bath three days after an interruption of the electrolysis, in copper electroplating, and in the drawings, reference numeral 1 denotes a copper foil layer, reference numeral 2 denotes a resin layer, and reference numeral 3 denotes a deposited copper layer.

### BEST MODE FOR CARRYING OUT THE INVENTION

Any bath solution useful for copper electroplating can be employed as the copper electroplating solution used in the present invention, including but not limited to a copper sulfate plating solution, a copper cyanide plating solution, and a copper pyrophosphate plating solution. Preferably, the copper electroplating solution is the copper sulfate plating solution. The description below gives typical examples using the copper sulfate plating solution as the copper electroplating solution. The compositions, components, and the like of any other plating solution are within the scope readily available to those skilled in the art in light of the following description concerning the copper sulfate plating solution, published literatures, and the like.

The copper electroplating solution of the present invention contains a compound having a —X—S—Y— structure. Preferably, X and Y in the structure of the compound are each independently selected from the group consisting of a hydrogen atom, a carbon atom, a nitrogen atom, a sulfur atom, and an oxygen atom, and in the specification, the compound is referred to as a sulfur-containing compound for convenience. More preferably, X and Y are each independently selected from the group consisting of a hydrogen atom, a carbon atom, a nitrogen atom, and a sulfur atom, further more preferably, from the group consisting of a hydrogen atom, a carbon atom, and a sulfur atom. X and Y can be the same only where they are carbon atoms.

In the formula: —X—S—Y—, S is bivalent, but X or Y does not need to be bivalent, and the atom X or Y can form a bond with any other atom depending on a valence thereof. For example, where X is hydrogen, the compound has a H—S—Y— structure.

More preferably, the sulfur-containing compound is a compound having a sulfonic acid group or an alkali metal sulfonate group in its molecule. One or more sulfonic acid groups or alkali metal sulfonate groups may be present in the brightener molecule.

Further more preferably, examples of the sulfur-containing compound include a compound having a —S—CH₂O—R—SO₃M structure in its molecule and a compound having a —S—R—SO₃M structure in its molecule (where M is a hydrogen atom or an alkali metal atom, and R is an alkyl group having 3 to 8 carbon atoms). Further more preferably, examples of the sulfur-containing compound include compound having the following structures (1) to (8):

(1) M-SO₃—(CH₂)ₐ—S—(CH₂)_{b}—SO₃-M;

(2) M-SO₃—(CH₂)ₐ—O—CH₂—S—CH₂—O—(CH₂)_{b}—SO₃-M;

(3) M-SO₃—(CH₂)ₐ—S—S—(CH₂)_{b}—SO₃-M;

(4) M-SO₃—(CH₂)ₐ—O—CH₂—S—S—CH₂—O—(CH₂)_{b}—SO₃-M;

(5) M-SO₃—(CH₂)ₐ—S—C(═S)—S—(CH₂)_{b}—SO₃-M;

(6) M-SO₃—(CH₂)ₐ—O—CH₂—S—C(═S)—S—CH₂—O—(CH₂)_{b}—SO₃-M;

in the formulas (1) to (6), a and b being each an integer of 3 to 8, and M being a hydrogen atom or an alkali metal atom,

(7) X—S—(CH₂)ₐ—SO₃-M; and

(8) X—S—CH₂—O—(CH₂)ₐ—SO₃-M,

in the formulas (7) and (8), a being an integer of 3 to 8, M being a hydrogen atom or an alkali metal atom, and X being any one of a hydrogen atom; an alkyl group with 1 to 10 carbon atoms; an aryl group; a chain or cyclic amine compound comprising 1 to 6 nitrogen atoms, 1 to 20 carbon atoms, and a plurality of hydrogen atoms; and a heterocyclic compound comprising 1 to 2 sulfur atoms, 1 to 6 nitrogen atoms, 1 to 20 carbon atoms, and a plurality of hydrogen atoms.

The sulfur-containing compound is generally used as a brightener but may be used for any other purpose within the scope of the present invention. The sulfur-containing compound used may include a single compound or a mixture of two or more compounds.

When the sulfur-containing compound is a brightener, it may be used at a concentration ranging from 0.1 to 100 mg/L, preferably from 0.5 to 10 mg/L. If the plating solution has a brightener concentration of 0.1 mg/L or less, the effect of facilitating growth of the plated copper coating film can be lost. A concentration over 100 mg/L is not preferred in terms of economy, because such a concentration brings less improvement in the cost effectiveness. When the sulfur-containing compound is used for other purposes than the brightener, the suitable range of usage amount thereof is readily available to those skilled in the art.

According the present invention, the copper electroplating solution may have a basic composition including but not limited to a composition useful for the prevailing copper electroplating. As far as the object of the present invention can be attained, in the basic composition, the components and concentrations may be changed, or additives may be added as desired. For example, the copper sulfate plating solution may be an aqueous solution having a basic composition of sulfuric acid, copper sulfate, and a water-soluble chlorine compound. Any composition for any known plating process with copper sulfate may be used as the basic composition of the plating solution without limit.

The concentration of the sulfuric acid in the copper sulfate plating solution is generally 30 to 400 g/L, preferably 170 to 210 g/L. For example, when a concentration is less than 30 g/L, the conductivity of the plating bath may be too low to produce a current through the plating bath. Further, when a concentration is more than 400 g/L, the dissolution of the copper sulfate may be prevented, which leads to precipitation of the copper sulfate.

The concentration of the copper sulfate in the copper sulfate plating solution is generally 20 to 250 g/L, preferably 60 to 180 g/L. For example, when a concentration is less than 20 g/L, the copper ions can be insufficiently supplied to the substrate to be plated so that no normal plated coating film can be deposited. In addition, copper sulfate is difficult to dissolve at a concentration more than 250 g/L.

Any water-soluble chlorine compound for known plating processes with copper sulfate may be used as the water-soluble chlorine compound contained in the copper sulfate plating solution without limit. The water-soluble chlorine compound includes but is not limited to hydrochloric acid, sodium chloride, potassium chloride, and ammonium chloride. A single type or a mixture of two or more types of the water-soluble chlorine compounds may be used.

The concentration of the chloride ions derived from the water-soluble chlorine compound in the copper sulfate plating solution used in the present invention is generally 10 to 200 mg/L, preferably 30 to 80 mg/L. When a chloride ion concentration is less than 10 mg/L, the normal function of the brighteners, surfactants, and the like may be deteriorated. Further, the concentration of more than 200 mg/L is not preferable because an amount of chlorine gas generated from the anode is increased.

The copper electroplating solution used in the present invention can optionally contain a surfactant. Any known surfactant useful as an additive for the general copper electroplating solution may be used. Preferably, examples of surfactants include but are not limited to compounds having the following structures (9) to (13):

(9) HO—(CH₂—CH₂—O)ₐ—H (where a is an integer of 5 to 500);

(10) HO—(CH₂—CH(CH₃)—O)ₐ—H (where a is an integer of 5 to 200);

(11) HO—(CH₂—CH₂—O)ₐ—(CH₂—CH(CH₃)—O)_{b}—(CH₂—CH₂—O)_{c}—H

(where a and c are each an integer, the sum of a and c is an integer of 5 to 250, and b is an integer of 1 to 100);

(12) —(NH₂CH₂CH₂)ₙ— (where n is 5 to 500); and

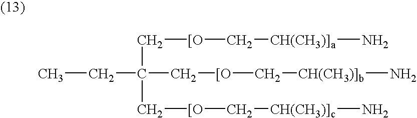

(where a, b, and c are each an integer of 5 to 200).

In the present invention, a single type or two or more types of the surfactants may be used. The surfactant used in the present invention can be used at a concentration typically ranging from 0.05 to 10 g/L, preferably from 0.1 to 5 g/L. When a concentration is not more than 0. 05 g/L in the plating solution, the wetting function may be insufficient so that many pinholes can be formed in the plated coating film, thereby it is difficult to normally deposit the plated coating film difficult. A concentration more than 10 g/L is not preferred in terms of economy, because improvement in the effect proportionate to the concentration is hardly provided.

As the substrate provided in the copper electroplating method of the present invention, a substrate formed of any material in any shape can be used, as far as it can withstand the conditions for the copper electroplating and a metal layer can be formed thereon by plating. The materials for the substrate include but are not limited to resins, ceramics, and metals. For example, the substrate made of resin includes printed wiring boards, and that made of ceramic includes wafers for semiconductors, but the material is not limited to them. The metal includes but is not limited to silicon, and the substrate made of metal includes but is not limited to silicon wafers. In the copper electroplating method of the present invention, via holes can advantageously be filled with electroplated copper, and the substrate provided in the present invention preferably has a through hole(s) or a via hole(s) and more preferably includes printed wiring boards and wafers each having a through hole(s) and/or a via hole(s).

The resins for use in the substrate include but are not limited to thermoplastic resins such as polyethylene resins including high density polyethylene, medium density polyethylene, branched low density polyethylene, linear low density polyethylene, and ultra high molecular weight polyethylene; polyolefine resins such as polypropylene resins, polybutadiene, polybutene resins, polybutylene resins, and polystyrene resins; halogen-containing resins such as polyvinyl chloride resins, polyvinylidene chloride resins, polyvinylidene chloride-vinyl chloride copolymer resins, chlorinated polyethylene, chlorinated polypropylene, and tetrafluoroethylene; AS resins; ABS resins; MBS resins; polyvinyl alcohol resins; polyacrylate resins such as polymethylacrylate; polymethacrylate resins such as polymethylmethacrylate; methylmethacrylate-styrene copolymer resins; maleic anhydride-styrene copolymer resins; polyvinylacetate resins; cellulose resins such as cellulose propionate resins and cellulose acetate resins; epoxy resins; polyimide resins; polyamide resins such as nylon; polyamide-imide resins; polyaryrate resins; polyetherimide resins; polyetheretherketone resins; poly(ethylene oxide) resins; various polyester resins such as PET resins; polycarbonate resins; polysulfone resins; polyvinylether resins; poly(vinyl butyral) resins; polyphenylene ether resins such as polyphenylene oxide; polyphenylene sulfide resins; poly(butylene telephthalate) resins; poly(methyl pentene) resins; polyacetal resins; vinyl chloride-vinyl acetate copolymers; ethylene-vinyl acetate copolymers; ethylene-vinyl chloride copolymers; copolymers thereof; and polymer blends thereof; and thermosetting resins such as epoxy resins; xylene resins; guanamine resins; diallyl phthalate resins; vinyl ester resins; phenolic resins; unsaturated polyester resins; furan resins; polyimide resins; polyurethane resins; maleic resins; melamine resins; urea resins; and any mixture thereof. Preferred resins include epoxy resins, polyimide resins, vinyl resins, phenolic resins, nylon resins, polyphenylene ether resins, polypropylene resins, fluororesins, and ABS resins. More preferred resins include epoxy resins, polyimide resins, polyphenylene ether resins, fluororesins, and ABS resins. Further more preferred resins include epoxy resins and polyimide resins. The resin substrate may be made of a single resin or different resins. The substrate may also be a composite comprising a base member of any other material and a resin applied or stacked thereon. The resin substrate usable for the present invention is not limited to molded-resin members and may include a composite comprising a resin and a reinforcing material such as a glass-fiber reinforcement arranged into the resin, and a composite comprising a base member of a base material such as ceramic, glass, and silicon, and a resin coating film formed thereon.

Examples of ceramics usable as the substrate material includes but not limited to oxide ceramics such as alumina (Al₂O₃), steatite (MgO.SiO₂), forsterite (2MgO.SiO₂), mullite (3Al₂O₃.2SiO₂), magnesia (MgO), spinel (MgO.Al₂O₃), and beryllia (BeO); non-oxide ceramics such as aluminum nitride and silicon carbide; and low temperature fired ceramics such as glass.

Prior to the copper electroplating, the substrate provided in the copper electroplating method is subjected to a treatment in which a part of the substrate to be plated is made electrically conductive. For example, an inner surface of the MVH is made electrically conductive before the MVH is filled with copper metal by the copper electroplating method of the present invention. This treatment for providing the MVH with electrical conductivity can be carried out by any known electrically conductivity process. Examples of the electrically conductivity process include but not limited to electroless copper plating, direct plating, conductive fine particle adsorption, and vapor plating.

The copper electroplating method according to the present invention is characterized by the use of an insoluble anode as an anode. If a soluble anode such as a phosphorus-containing copper anode is used in the copper electroplating with the plating solution containing the sulfur-containing compound as described above, a reaction can occur during an interruption of the electrolysis between the soluble anode and the sulfur-containing compound to form decomposition products through the cleavage of an S—X or S—Y single bond of the sulfur-containing compound, which can be adverse to the copper electroplating, although the invention should not be bound by the theory. For example, the above-described brightener having the structure: (1) M-SO₃—(CH₂)ₐ—S—(CH₂)_{b}—SO₃-M can give decomposition products having the structure: M-SO₃—(CH₂)ₐ—S— or —S—(CH₂)_{b}—SO₃-M. Although the invention should not be bound by theory, as the reason of adversely affecting the copper electroplating by the decomposition product, acceleration of the metal deposition in the copper electroplating by the decomposition product is considered. For example, in the copper electroplating, when the via is filled by abnormal acceleration of the electroplated copper deposition which is induced by the decomposition products, the copper deposition rate at the opening of the via is made greater than that near the bottom of the via so that there is a problem that the via is filled with void left. In addition, it may be considered that the deposited copper may form bulky grains, resulting in an electroplated copper layer that is poor in adhesion and heat resistance other than the via filling.

The copper electroplating method of the present invention employs an insoluble anode as an anode, and therefore the decomposition reaction on the sulfur-containing compound described above is prevented from occurring, so that the copper electroplating bath is substantially free of the decomposition products. Accordingly, in the copper electroplating method of the present invention, no void is left in the via filling, and no bulky grain is formed in the metal deposition, so that it is possible to avoid the disadvantages in usage of the sulfur-containing compound a brightener, which has been a problem in the conventional methods. In other words, according to the present invention, the use of the insoluble anode in the copper electroplating substantially eliminates the decomposition products that would otherwise be formed through the cleavage of an S—X or S—Y bond of the sulfur-containing compound, and the bath solution can be controlled to be in conditions suitable for desired copper electroplating.

As the insoluble anode used in the present invention, there can be used an anode made of any material as far as it does not dissolve or release metal into the copper electroplating solution. The materials for the anode include but are not limited to iridium oxide, platinum-clad titanium, platinum, graphite, ferrite, lead dioxide, and titanium or stainless steel coated with oxide of a platinum group element.

In the copper electroplating method of the present invention, the plating temperature (solution temperature) is appropriately set depending on the type of the plating bath, being generally 10 to 440° C., preferably 20 to 30° C. When a plating temperature is below 10° C., the productivity can be decreased, because the conductivity of the plating solution is decreased so that the current density cannot be increased during the electrolysis and the growth rate of the plated coating film is lower. A plating temperature above 40° C. is not preferred, because the brightener can be decomposed at such a temperature.

A power source used in the copper electroplating method of the present invention is a direct current (DC) power source. The anodic current-density to be applied is appropriately set depending on the type of the plating bath, being generally 0.1 to 10 A/dm², preferably 1 to 3 A/dm². In case of a current density lower than 0.1 A/dm², the anode can uneconomically need a large area. Further, a current density higher than 10 A/dm² is not preferable because the oxidative decomposition of the brightener component is increased by oxygen generated from the anode during electrolysis.

In the plating method of the present invention, stirring may safely be carried out. Preferably, stirring is carried out to uniformly supply the copper ions and the additives to the surface of the material to be plated. Aeration or jet can be used for the stirring. Additionally, batch filtration or circulating filtration may be carried out. The plating solution is preferably circulated and filtrated with a filter, so that the temperature of the plating solution can be uniform, and dusts, precipitates, and the like can be removed from the plating solution.

According to the copper electroplating method of the present invention, a composite material is produced which comprises a substrate and a copper layer formed on the substrate. According to the method of the present invention, even if the copper electroplating process following the initial make-up of the electrolytic bath is interrupted, and the bath is allowed to stand for a certain time period and then used again, the copper layer of the produced composite material can be free of bulky grains, and the via can be filled with no remaining void.

### EXAMPLES

Preparation of Test Parts

Test parts subjected to the copper electroplating were prepared by the following process in Examples.

Onto a printed wiring board having a copper foil on a surface thereof, an epoxy resin for build-up process (Matsushita Electric Works, Ltd.) was applied to have a thickness of 80 μm and cured. A copper foil 10 μm in thickness was bonded to the surface, and carbon dioxide gas laser was used to bore a hole in the copper foil and the epoxy resin layer, so that an MVH about 80 μm in diameter and about 80 μm in depth was formed. Electroless copper plating was carried out thereon to form a copper coating film 0.2 to 0.3 μm in thickness for producing a test part. The electroless copper plating was carried out as follows. The board was treated with a conditioner at 50° C. for five minutes and then washed with water. Soft etching was carried out thereon at 25° C. for two minutes, and then the board was washed with water. Thereafter, an activation process with acid was carried out at room temperature for one minute, and then the board was washed with water before pre-dipping at 25° C. for one minute. Subsequently, catalyst treatment was carried out at 25° C. for five minutes. The board was washed with water and then treated in an accelerator at 25° C. for five minutes. After water washing, electroless plating was carried out at 25° C. for 20 minutes.

The test part obtained was subjected to the copper electroplating under the conditions for the copper electroplating as shown in each of Examples 1 to 4 and Comparative Examples 1 to 4 described below. Thereafter, the test part was cut and polished to observe the cross section of the MVH.

### Example 1

Copper Electroplating with Insoluble Anode Conditions for Copper Electroplating Plating Solution:

| | | |
|---|---|---|
| Sulfuric Acid | 180 | g/L |
| Copper Sulfate | 150 | g/L |
| Chloride Ion | 60 | mg/L |
| Surfactant | 0.35 | g/L |
| Brightener | 5 | mg/L |

Surfactant: HO—(CH₂—CH₂—O)ₐ—(CH₂—CH(CH₃)—O)_{b}—(CH₂—CH₂—O)_{c}—H

(where a+c=25, b=30)

Brightener: Na—SO₃—(CH₂)₃—S—S—(CH₂)₃—SO₃—Na

Current Density: 2 A/dm²

Plating Time: 60 minutes

Cathode: Build-Up Board

Cathode Area: 1 dm²

Anode: Iridium Oxide

Anode Area: 1 dm²

### Comparative Example 1

Copper Electroplating with Soluble Anode Conditions for Copper Electroplating Plating Solution:

| | | |
|---|---|---|
| Sulfuric Acid | 180 | g/L |
| Copper Sulfate | 150 | g/L |
| Chloride Ion | 60 | mg/L |
| Surfactant | 0.35 | g/L |
| Brightener | 5 | mg/L |

Surfactant: HO—(CH₂—CH₂—O)ₐ—(CH₂—CH(CH₃)—O)_{b}—(CH₂—CH₂—O)_{c}—H

(where a+c=25, b=30)

Brightener: Na—SO₃—(CH₂)₃—S—S—(CH₂)₃—SO₃—Na

Current Density: 2 A/dm²

Plating Time: 60 minutes

Cathode: Build-Up Board

Cathode Area: 1 dm²

Anode: Phosphorus-Containing Copper Anode

Anode Area: 1 dm²

### Example 2

Copper Electroplating with Insoluble Anode Conditions for Copper Electroplating Plating Solution:

| | | |
|---|---|---|
| Sulfuric Acid | 200 | g/L |
| Copper Sulfate | 100 | g/L |
| Chloride Ion | 60 | mg/L |
| Surfactant | 0.35 | g/L |
| Brightener | 5 | mg/L |

Surfactant:

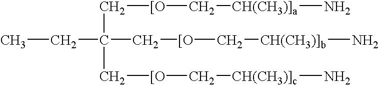

(where a, b, and c are 20.)

Brightener: Na—SO₃—(CH₂)₃—S—S—(CH₂)₃—SO₃—Na

Current Density: 2 A/dm²

Plating Time: 60 minutes

Cathode: Build-Up Board

Cathode Area: 1 dm²

Anode: Titanium-Clad Platinum

Anode Area: 1 dm²

### Comparative Example 2

Copper Electroplating with Soluble Anode Conditions for Copper Electroplating Plating Solution:

| | | |
|---|---|---|
| Sulfuric Acid | 200 | g/L |
| Copper Sulfate | 100 | g/L |
| Chloride Ion | 60 | mg/L |
| Surfactant | 0.35 | g/L |
| Brightener | 5 | mg/L |

Surfactant:

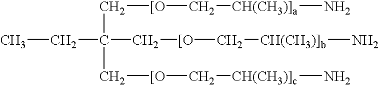

(where a, b, and c are 20.)

Brightener: Na—SO₃—(CH₂)₃—S—S—(CH₂)₃—SO₃—Na

Current Density: 2 A/dm²

Plating Time: 60 minutes

Cathode: Build-Up Board

Cathode Area: 1 dm²

Anode: Phosphorus-Containing Copper Anode

Anode Area: 1 dm²

### Example 3

Copper Electroplating with Insoluble Anode Conditions for Copper Electroplating Plating Solution:

| | | |
|---|---|---|
| Sulfuric Acid | 200 | g/L |
| Copper Sulfate | 100 | g/L |
| Chloride Ion | 60 | mg/L |
| Surfactant | 0.50 | g/L |
| Brightener | 5 | mg/L |

Surfactant: HO—(CH₂—CH₂—O)₁₂₀—H

Brightener: Na—SO₃—(CH₂)₃—O—CH₂—S—CH₂—O—(CH₂)₃—SO₃—Na

Current Density: 2 A/dm²

Plating Time: 60 minutes

Cathode: Build-Up Board

Cathode Area: 1 dm²

Anode: Iridium Oxide

Anode Area: 1 dm²

### Comparative Example 3

Copper Electroplating with Soluble Anode Conditions for Copper Electroplating Plating Solution:

| | | |
|---|---|---|
| Sulfuric Acid | 200 | g/L |
| Copper Sulfate | 100 | g/L |
| Chloride Ion | 60 | mg/L |
| Surfactant | 0.30 | g/L |
| Brightener | 5 | mg/L |

Surfactant: HO—(CH₂—CH₂—O)₁₂₀—H

Brightener: Na—SO₃—(CH₂)₃—O—CH₂—S—CH₂—O—(CH₂)₃—SO₃—Na

Current Density: 2 A/dm²

Plating Time: 60 minutes

Cathode: Build-Up Board

Cathode Area: 1 dm²

Anode: Phosphorus-Containing Copper Anode

Anode Area: 1 dm²

### Example 4

Copper Electroplating with Insoluble Anode Conditions for Copper Electroplating Plating Solution:

| | | |
|---|---|---|
| Sulfuric Acid | 200 | g/L |
| Copper Sulfate | 100 | g/L |
| Chloride Ion | 60 | mg/L |
| Surfactant 1 | 2 | g/L |
| Surfactant 2 | 0.1 | g/L |
| Brightener | 5 | mg/L |

Surfactant 1: —(NH₂CH₂CH₂)₁₀₀—

Surfactant 2: HO—(CH₂—CH₂—O)₁₂₀—H

Brightener: Na—SO₃—(CH₂)₃—S—C(═S)—S—(CH₂)₃—SO₃—Na

Current Density: 2 A/dm²

Plating Time: 60 minutes

Cathode: Build-Up Board

Cathode Area: 1 dm²

Anode: Iridium Oxide

Anode Area: 1 dm²

### Comparative Example 4

Copper Electroplating with Soluble Anode Conditions for Copper Electroplating Plating Solution:

| | | |
|---|---|---|
| Sulfuric Acid | 200 | g/L |
| Copper Sulfate | 100 | g/L |
| Chloride Ion | 60 | mg/L |
| Surfactant 1 | 2 | g/L |
| Surfactant 2 | 0.1 | g/L |
| Brightener | 5 | mg/L |

Surfactant 1: —(NH₂CH₂CH₂)₁₀₀—

Surfactant 2: HO—(CH₂—CH₂—O)₁₂₀—H

Brightener: Na—SO₃—(CH₂)₃—S—C(═S) —S—(CH₂)₃—SO₃—Na

Current Density: 2 A/dm²

Plating Time: 60 minutes

Cathode: Build-Up Board

Cathode Area: 1 dm²

Anode: Phosphorus-Containing Copper Anode,

Anode Area: 1 dm²

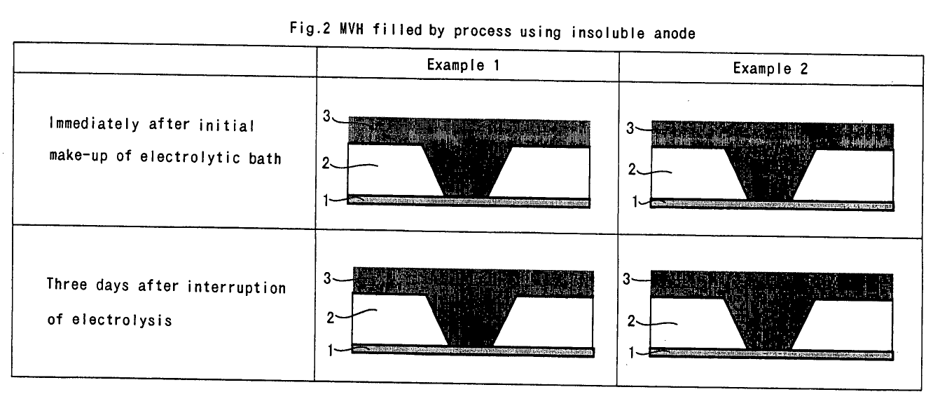

It was confirmed, from Examples 1 and 2 each using an insoluble anode, that the MVH 80 μm in diameter and 80 μm in depth was completely filled with the plated copper deposit with no void left as shown in FIG. 2, when the copper electroplating solution was used immediately after the initial make-up. Further, as shown in FIG. 2, good filling was observed even in the plating bath which was allowed to stand for three days after the stop of the electrolysis. Although not shown in the drawings, in Examples 3 and 4, good filling was also observed, both when the copper electroplating bath was used immediately after the initial make-up and when the bath was used again after the three-day standing from the interruption of the electrolysis.

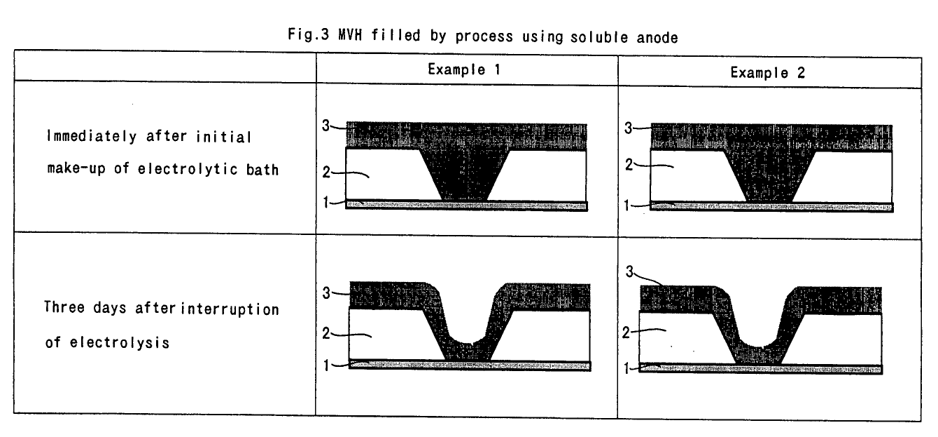

In Comparative Examples 1 and 2 each using a phosphorus-containing copper anode as the soluble anode, good filling was obtained when the copper electroplating solution was used immediately after the initial make-up, but good filling was not attained when the plating bath was used again after the three-day standing from the interruption of the electrolysis, as shown in a schematic view of FIG. 3. Similarly, although not shown in the drawings, in Comparative Examples 3 and 4, good filling was observed when the copper electroplating solution was used immediately after the initial make-up, but good filling was not attained when the plating bath was used again after the three-day standing from the interruption of the electrolysis.

Industrial Applicability

As described above, in the copper electroplating method of the present invention using a copper electroplating solution containing a specific brightener, an insoluble anode is used, so that during the interruption of the electrolysis, the sulfur-containing compound can be prevented from generating decomposition products which adversely affect the copper electroplating. Therefore, even after a lapse of a certain time period from the initial make-up of the electrolytic bath, the metal can stably be deposited, the filled via can be formed, and the MVH can be filled with the metal with no void left. In addition, the time period for filling the MVH with a good conductor of metal with no void left can be shorter than that for other processes than the copper electroplating.

1. A copper electroplating method, comprising:
using an insoluble anode and a copper electroplating solution containing a compound having a —X—S—Y— structure (where X and Y are each independently selected from the group consisting of a hydrogen atom, a carbon atom, a sulfur atom, a nitrogen atom, and an oxygen atom, and X and Y can be the same only where they are carbon atoms); and
using direct current to plate a substrate.

2. A copper electroplating method, comprising:
using an insoluble anode and a copper electroplating solution containing a compound having a —X—S—Y— structure (where X and Y are each independently selected from the group consisting of a hydrogen atom, a carbon atom, a sulfur atom, and a nitrogen atom, and X and Y can be the same only where they are carbon atoms); and
using direct current to plate a substrate.

3. The copper electroplating method according to claim 2, wherein the compound having a —X—S—Y— structure (where X and Y are each independently selected from the group consisting of a hydrogen atom, a carbon atom, a sulfur atom, and a nitrogen atom, and X and Y can be the same only where they are carbon atoms), is selected from the group consisting of:
(1) M-SO₃—(CH₂)ₐ—S—(CH₂)_{b}—SO₃-M;
(2) M-SO₃—(CH₂)ₐ—O—CH₂—S—CH₂—O—(CH₂)_{b}—SO₃-M;
(3) M-SO₃—(CH₂)ₐ—S—S (CH₂)_{b}—SO₃-M;
(4) M-SO₃—(CH₂)ₐ—O—CH₂—S—S—CH₂—O—(CH₂)_{b}—SO₃-M;
(5) M-SO₃—(CH₂)ₐ—S—C(═S)—S—(CH₂)_{b}—SO₃-M;
(6) M-SO₃—(CH₂)ₐ—O—CH₂—S—C(═S)—S—CH₂—O—(CH₂)_{b}—SO₃-M;
in the formulas (1) to (6), a and b being each an integer of 3 to 8, M being a hydrogen atom or an alkali metal atom,
(7) X—S—(CH₂)ₐ—SO₃-M; and
(8) X—S—CH₂—O—(CH₂)ₐ—SO₃-M,
in the formulas (7) and (8), a being an integer of 3 to 8, M being a hydrogen atom or an alkali metal atom, and X being any one of a hydrogen atom; an alkyl group with 1 to 10 carbon atoms; an aryl group; a chain or cyclic amine compound comprising 1 to 6 nitrogen atoms, 1 to 20 carbon atoms, and a plurality of hydrogen atoms; and a heterocyclic compound comprising 1 to 2 sulfur atoms, 1 to 6 nitrogen atoms, 1 to 20 carbon atoms, and a plurality of hydrogen atoms.

4. The copper electroplating method according to any one of claims 1 to 3, wherein the compound having the —X—S—Y— structure is a brightener.

5. The copper electroplating method according to any one of claims 1 to 4, wherein the compound having the —X—S—Y— structure is present at a concentration of 0.1 to 100 mg/L in the copper electroplating solution.

6. The copper electroplating method according to any one of claims 1 to 5, wherein the copper electroplating solution further contains a surfactant.

7. The copper electroplating method according to any one of claims 1 to 6, wherein the insoluble anode is selected from the group consisting of iridium oxide, platinum-clad titanium, lead dioxide coated titanium, lead alloys, ferrite, and stainless steels.

8. The copper electroplating method according to any one of claims 1 to 7, wherein the substrate is a printed wiring board or a wafer.

9. The copper electroplating method according to any one of claims 1 to 8, wherein the substrate has a through hole or a via hole.

10. A composite material obtained by the method according to any one of claims 1 to 9.
